(19) United States
(12) Patent Application Publication
(10) Pub. No.: US 2025/0055529 A1
(43) Pub. Date: Feb. 13, 2025

(54) METHOD PERFORMED BY USER EQUIPMENT, AND USER EQUIPMENT

(71) Applicant: SHARP KABUSHIKI KAISHA, Sakai City, Osaka (JP)

(72) Inventors: Xiaojun MA, Shanghai (CN); Renmao LIU, Shanghai (CN)

(21) Appl. No.: 18/718,010

(22) PCT Filed: Dec. 7, 2022
(86) PCT No.: PCT/CN2022/137195

§ 371 Date: Jun. 7, 2024

(30) Foreign Application Priority Data
Dec. 10, 2021 (CN) 202111513925.2

(51) Int. Cl. H04B 7/06; H04L 5/00

(52) U.S. Cl. CPC H04B 7/0626; H04L 5/0048

(57) ABSTRACT

Provided in the present invention are a method performed by user equipment, and user equipment. The method performed by user equipment includes: the user equipment determining, according to a group number of a CSI-RS resource set, the number of bits of a CSI-RS resource availability indication in paging early indication (PEI)-DCI information; and determining CSI-RS resource availability according to bits of the CSI-RS resource availability indication in the PEI-DCI information, the bits corresponding to the determined number of bits, a radio resource control (RRC) state of the user equipment being IDLE state or INACTIVE state.

### TECHNICAL FIELD

The present invention relates to the technical field of wireless communications, and in particular to a method performed by user equipment, and corresponding user equipment.

### BACKGROUND

User experience is one of the key factors of the success of 5G/NR, and is not merely a user-experienced data rate and delay, and reduction in terminal power consumption is also an important aspect. The enhanced technical solution of reduction in terminal power consumption is one of the elements of the success of 5G/NR. Although some existing techniques have been used for the reduction in terminal power consumption, an additional enhanced evolved technology is still one of the key technologies in future development. For example, the power consumption reduction technology may be applied to a terminal in IDLE state or INACTIVE state, thereby facilitating further reduction in power consumption of a terminal device in a corresponding state while ensuring a communication capability, or improving a signal receiving capability, and achieving some other benefits.

### SUMMARY

In order to address at least part of the aforementioned issues, the present invention provides a method performed by user equipment, and user equipment. Via this method, user equipment receives an indication message to acquire the availability of a reference signal configured in a network, comprising the manner in which a related indication signal corresponds to a configured resource parameter, a time duration corresponding to the indication signal, etc. The terminal acquires related parameters via the indication signal, and by receiving the reference signal, the terminal can further acquire an accurate measurement or parameter estimate, more sleep time, better signal receiving capability, or the like, so that the terminal achieves benefits such as reduced power consumption and improved receiving capability, thereby improving network service capability, expanding network compatibility, and greatly reducing communication network deployment costs.

According to the present invention, provided is a method performed by user equipment (UE), comprising: the terminal determining a reference frame according to a capacity of a paging early indication (PEI) and a terminal identifier; and acquiring PEI information according to the reference frame, determining a CSI-RS resource availability indication in the PEI information, and determining CSI-RS resource availability.

Preferably, determining a CSI-RS resource availability indication in the PEI information comprises: determining an indication duration of a CSI-RS resource availability indication, wherein the indication duration is composed of a starting point and a length, the starting point being determined by the reference frame and an offset, and the length being determined according to the offset, the capacity of the PEI, and a paging parameter.

Preferably, determining CSI-RS resource availability comprises: a CSI-RS resource availability indication determined by the terminal within the duration being prioritized over a CSI-RS resource availability indication determined by the terminal according to an indication in a paging PDCCH.

Preferably, in the method according claim 1, determining a CSI-RS resource availability indication in the PEI information comprises: determining, by the terminal, a bit length and/or a mapping method for the CSI-RS resource availability indication in the PEI information.

Preferably, the terminal determines, according to the size of PEI-DCI, the bit length and/or the mapping method for the CSI-RS resource availability indication in the PEI information.

Preferably, the terminal determines the bit length and/or the mapping method for the CSI-RS resource availability indication in the PEI information according to a higher layer indication, the higher layer indication being a scrambling RNTI used by the PEI-DCI and/or a bit indication relating to a CSI-RS availability indication method in the PEI information.

Preferably, the terminal determines the size of the PEI-DCI according to the determined bit length of the CSI-RS resource availability indication in the PEI information.

Preferably, the terminal acquiring PEI information according to the reference frame comprises: determining the position of a transmission occasion used by the PEI information, the position being determined by the capacity of the PEI and a sequence number of a terminal-paged PO in a PF.

Furthermore, according to the present invention, provided is user equipment, comprising: a processor; and a memory, having instructions stored therein, wherein the instructions, when run by the processor, perform the above method.

According to the present invention, reference signal reception can enable a terminal to be capable of further acquiring an accurate measurement or parameter estimate, more sleep time, a better signal receiving capability, or the like, so that the terminal achieves benefits such as reduction in power consumption and improvement in the receiving capability, thereby improving a network service capability and expanding network compatibility, such that costs of communication network deployment are greatly reduced.

### BRIEF DESCRIPTION OF THE DRAWINGS

The above and other features of the present invention will be more apparent from the following detailed description in combination with the accompanying drawings, in which:

FIG. 1 is a flowchart showing a method performed by user equipment according to an embodiment of the present invention.

FIG. 2 is a schematic diagram showing a method performed by a user to determine PEI information according to an embodiment of the present invention.

FIG. 3 is a schematic diagram of a PEI-DCI structure according to an embodiment of the present invention.

FIG. 4 is a schematic diagram showing determination of CSI-RS resource availability within a duration according to an embodiment of the present invention.

FIG. 5 is a flowchart showing a method performed by user equipment according to an embodiment of the present invention.

FIG. 6 is a flowchart showing a method performed by user equipment according to an embodiment of the present invention.

FIG. 7 is a flowchart showing a method performed by user equipment according to an embodiment of the present invention.

FIG. 8 is a schematic diagram showing user equipment determining a detected PEI occasion according to an embodiment of the present invention.

FIG. 9 is a block diagram schematically showing user equipment according to the present invention.

### DETAILED DESCRIPTION

The following describes the present invention in detail with reference to the accompanying drawings and specific embodiments. It should be noted that the present invention should not be limited to the specific embodiments described below. These embodiments are merely provided as examples to conveniently convey the range of the subject matter to those skilled in the art. In addition, detailed descriptions of well-known technologies not directly related to the present invention are omitted for the sake of brevity, in order to avoid obscuring the understanding of the present invention.

Typically, all terms used herein will be interpreted according to the ordinary meaning thereof in the related technical field unless different meanings are clearly presented and/or implied in the context where the terms are used. Unless specified otherwise clearly, all references to a/one/the element, device, assembly, component, step, etc., should be publicly interpreted as referring to at least one instance of the element, device, assembly, component, step, etc. The steps of any method disclosed herein do not need to be performed in the exact order disclosed unless one step has to be explicitly described as being after or before another step and/or one step has to be after or before another step as implied. In appropriate cases, any feature of any embodiment disclosed herein is applicable to any other embodiment. Likewise, any advantage of any embodiment is applicable to any other embodiment, and vice versa.

In the following description, a 5G/NR mobile communication system and later evolved versions thereof are used as exemplary application environments to describe a plurality of embodiments according to the present invention in detail. However, it is to be noted that the present invention is not limited to the following embodiments, but is applicable to many other wireless communication systems, such as a communication system after 5G, a 4G mobile communication system before 5G, and a 802.11 wireless network.

Some terms involved in the present invention are described below. Unless otherwise specified, the terms used in the present invention use the definitions herein. The terms given in the present invention may vary in LTE, LTE-Advanced, LTE-Advanced Pro, NR, and subsequent or other communication systems, but unified terms are used in the present invention. When applied to a specific system, the terms may be replaced with terms used in the associated system.
3GPP: 3rd Generation Partnership Project
LTE: Long Term Evolution
NR: New Radio
UE: User Equipment
gNB: NR base station
FR1: Frequency range 1 as defined in TS 38.104
FR2: Frequency range 2 as defined in TS 38.104
BWP: Bandwidth Part
SFN: System Frame Number
OFDM: Orthogonal Frequency Division Multiplexing
CP: Cyclic Prefix
TA: Timing Advance
SCS: Sub-Carrier Spacing
RB: Resource Block
RE: Resource Element
CRB: Common Resource Block
PRB: Physical Resource Block
VRB: Virtual Resource Block
REG: Resource Element Group
EPRE: Energy Per Resource Element
TDD: Time Division Duplexing
FDD: Frequency Division Duplexing
CSI: Channel State Information
DCI Downlink Control Information
MCS: Modulation and Coding Scheme
SRS: Sounding Reference Signal
DMRS: Demodulation Reference Signal
CSI-RS: Channel State Information Reference Signal
TRS: Tracking Reference Signal
CRC: Cyclic Redundancy Check
SFI: Slot Format Indication
QCL: Quasi Co-Location
HARQ: Hybrid Automatic Repeat Request
SIB: System Information Block
SIB1: System Information Block Type 1
PSS: Primary Synchronization Signal
SSS: Secondary Synchronization Signal
MIB: Master Information Block
SSB: Synchronization Signal Block
CORESET: Control Resource Set
RACH: Random-Access Channel
PBCH: Physical Broadcast Channel
PUCCH: Physical Uplink Control Channel
PUSCH: Physical Uplink Shared Channel
PRACH: Physical Random-Access Channel
PDSCH: Physical Downlink Shared Channel
PDCCH: Physical Downlink Control Channel
UL-SCH: Uplink Shared Channel
DL-SCH: Downlink Shared Channel
NZP-CSI-RS: Not-Zero-Power CSI-RS
C-RNTI: Cell Radio Network Temporary Identifier
P-RNTI: Paging RNTI
RA-RNTI: Random Access RNTI
CS-RNTI: Configured Scheduling RNTI
SI-RNTI: System Information RNTI
TC-RNTI: Temporary C-RNTI
DRX: Discontinuous Reception
PEI: Paging Early Indication

The following is a description of technologies associated with the solution of the present invention. Unless otherwise specified, the same terms in the specific embodiments have the same meanings as in the associated technologies.

It is worth pointing out that the user, the user equipment, the terminal, and the terminal device in the specification of the present invention have the same meaning, and the UE herein may also represent a terminal, which will not be specifically differentiated or defined hereinafter. Similarly, network devices are devices communicating with a terminal, and include, but are not limited to, a base station device, a gNB, an eNB, a wireless AP, etc., and will not be specifically differentiated or defined hereinafter. Herein, description may also be provided by using a base station as a form of a network device that is implemented, and in a specific implementation, other network device forms may be easily used for replacement.

In NR, one slot may include 14 (in a normal CP scenario) or 12 (in an extended CP scenario) OFDM symbols, and multiple slots may form a subframe and a radio frame. In NR, one radio frame has a length of 10 milliseconds. Depending on different subcarrier spacing parameters, a radio frame may consist of several slots. For example, when the subcarrier spacing is 15 kHz, one radio frame consists of 10 slots. The terminal may determine the slot location according to parameters such as a frame number SFN of the radio frame and the sequence number of the slot in the radio frame. The terminal may also determine a symbol location of signal transmission in the time domain according to the sequence number of a symbol in the slot. Resources in NR may be identified by resource blocks and resource elements. The resource block (RB) may be defined in the frequency domain as N_{sc}^{RB}=12 consecutive subcarriers. For example, for a 15 kHz subcarrier spacing (SCS), one RB is 180 kHz in the frequency domain. The resource element (RE) may determine one unit on a time-frequency grid, represent one subcarrier in the frequency domain, and represent one OFDM symbol in the time domain. A typical subcarrier spacing is 15 kHz×2^{μ}, and μ may be an integer value.

A CSI-RS reference signal may be configured in the network and is used by the terminal to implement functions such as channel measurement and beam management. A CSI-RS signal parameter may be configured to the terminal in the form of a CSI-RS resource, and one terminal may be configured with one or more CSI-RS resources. One or more CSI-RS resources may further form a CSI-RS resource set, and one terminal may be configured with one or more resource sets. Several parameters are configured in each CSI-RS resource. For example, a time domain period and offset configuration, a frequency domain location and bandwidth configuration, a power configuration, a code division parameter configuration, a QCL configuration, a frequency domain density parameter, a subcarrier location, and the like define one CSI-RS signal.

The terminal determines, according to related configuration parameters, related parameters for transmitting a CSI-RS signal on a time-frequency resource. For example, the terminal may determine a slot location for CSI-RS transmission according to configuration parameters of a period T_{CSI-RS} and an offset T_{offset} of the CSI-RS signal. The terminal determines that a radio frame n_{f} and a slot n_{s,f}^{μ} of which the radio frame and a slot number satisfy (Nₛₗₒₜ^{frame,μ}n_{f}+n_{s,f}^{μ}−T_{offset})mod T_{CSI-RS}=0 are the frame number and the slot number for CSI-RS signal transmission. The terminal may further determine, according to the configuration parameters, the sequence number of the used symbol of the CSI-RS in the slot, the starting position and a bandwidth of the CSI-RS in the frequency domain, etc. The network may configure a frequency domain density and a frequency domain allocation parameter of the CSI-RS, and the terminal may determine, according to the configuration, which REs in an RB are occupied by the CSI-RS for transmission. According to different configuration parameters, the CSI-RS may use some of the REs in the RB in the frequency domain. For example, the frequency domain density parameter used by the CSI-RS is 3, so that three REs of 12 REs determined on one symbol and one RB are used for CSI-RS signal transmission, and the remaining REs are not used for CSI-RS signal transmission. The sequence number of the RE used by the CSI-RS signal on the RB may be determined by a configuration parameter. For example, a four-bit bitmap is used to determine which REs of every four REs are used for transmission of the CSI-RS signal. The sequence number may also be used for indication. For example, 0 indicates starting from the first RE, 1 indicates starting from the second RE, and so on. The network may also configure several other parameters, and the terminal may determine the characteristics of the CSI-RS signal according to the related configuration, and use the same for related reception, measurement, or the like.

Therefore, the terminal may determine, according to related parameters, several time-frequency locations corresponding to one CSI-RS resource. Transmission of a related CSI-RS signal may be present in these time-frequency locations, referred to as several transmission occasions of said CSI-RS resource. The terminal may receive the CSI-RS signal on the foregoing transmission occasions, and the CSI-RS signal is for measurement, signal reception, or the like.

According to different configuration parameters, the CSI-RS may be divided into a plurality of types. For example, an NZP-CSI-RS is a not-zero-power CSI-RS. That is, transmission power of the CSI-RS is not zero. According to different configuration parameters, the CSI-RS may also be divided into periodic, semi-permanent, and aperiodic signal types. For a periodic CSI-RS, after the configuration takes effect, the associated CSI-RS resource repeatedly occurs on the time-frequency resources according to a certain period. Semi-permanent and aperiodic CSI-RS resources need to be activated by means of a manner indicated by a MAC-CE or DCI. The terminal may implement different functions according to resources of different CSI-RSs and related report indications, etc. A CSI-RS signal for time-frequency tracking may also be referred to as a TRS. In the present invention, CSI-RS is uniformly used as the name for CSI-RSs of different types or parameters applicable to the present invention or other signals capable of implementing similar functions.

The network transmits an SSB signal according to a certain period. An SSB may include a variety of synchronization signals, such as an SSS, a PSS, and the like. The network may use a spatial filter (also referred to as a beam) to perform signal transmission and reception. The beam used in the network may be an analog beam or a digital beam or a combination thereof. The network may transmit an SSB by using a beam. For example, the network transmits SSBs by using eight beams, so that the SSBs in the transmission period may be numbered SSB0 to SSB7, respectively representing SSBs transmitted using the corresponding beams. The terminal may select, according to different locations, the optimal beam to perform signal reception or transmission, so as to achieve improved communication performance.

A QCL parameter is used in the network to indicate a spatial relationship between different signals. That is, two signals satisfying a QCL relationship have a certain spatial channel association. For example, the network configures two signals to satisfy a certain QCL type relationship. The terminal may use the same certain parameter when the terminal processes the two signals, or a parameter obtained by means of one signal may be applied to reception or transmission of the other signal. For example, the QCL type of two signals is QCL-typeA, and parameters such as Doppler shift, Doppler spread, average delay, and delay extension obtained via one signal may be applied to the other signal. That is, these parameters may be shared. As another example, the QCL type of two signals is QCL-typeC, and parameters such as Doppler shift and a delay extension parameter of one signal may be obtained via one signal. As another example, the QCL type is QCL-typeD, and beam parameter information of one signal may be obtained by means of one signal. There may also be other QCL types, and a user may perform identification according to related parameters during application. A user may also apply related parameters between more signals that mutually satisfy a QCL relationship, and the specific procedures will not be described one by one.

The CSI-RS signal transmitted by a network device may be transmitted by using a beam, and in the network, a reference signal may be configured for the CSI-RS as a signal satisfying a QCL relationship therewith. For example, the network may configure an SSB i to serve as a reference signal of a CSI-RS signal that satisfies a certain QCL type, and the terminal may consider that the SSB i has some of the same channel parameters as the CSI-RS, such as a spatial signal parameter, a Doppler shift parameter, and the like. If another signal on the terminal side and the SSB i satisfy the QCL, the terminal may also acquire a related parameter by means of receiving or measuring the CSI-RS, and apply the related parameter to reception of the signal.

The network may transmit a DCI message to the terminal via a PDCCH channel. The terminal may determine a series of time-frequency resources and other parameters according to PDCCH configurations, and perform DCI detection on the determined resources. Upon detecting the DCI message correctly, the terminal may perform a related action according to the content indicated by the DCI. Transmission on the PDCCH is performed by using a beam. The network may configure a reference signal of the PDCCH of which a DM-RS port satisfies the QCL relationship, for example, configure a certain SSB as a QCL reference signal of the PDCCH. The terminal may also determine a default QCL reference signal of the PDCCH according to configurations of the PDCCH, for example, determine a certain SSB as a reference signal thereof according to locations of time-frequency resources. The configuration parameters of the PDCCH channel include a search space set parameter, a CORESET parameter, etc. The terminal may monitor for, according to a configuration, a PDCCH candidate set on a resource determined by a related search space set and CORESET, which is referred to as a PDCCH monitoring occasion. The terminal may receive the PDCCH on the PDCCH monitoring occasion according to a spatial filter parameter of the QCL reference signal of the PDCCH, and detect whether related DCI is correctly received.

According to different situations such as whether the terminal is connected to a wireless network and whether the wireless connection is suspended, terminals in the network may be divided into different states, such as a connected state, IDLE state, INACTIVE state, and the like. A radio link connection is set up between a user in the connected state and the network, and is used to perform data transmission or related service processing. A terminal in IDLE state or INACTIVE state also maintains a certain connection to the network. For example, the terminal needs to monitor, according to a relevant configuration or parameter, a broadcast message and a paging message transmitted by the network, or perform relevant measurement, or the like. The processing of the behavior of the user in IDLE state is similar to the processing of the behavior of the user in INACTIVE state in many aspects of the present invention. In order to avoid redundancy, unless indicated otherwise, in related embodiments of the present invention, actions relating to the terminal in IDLE state can also be applied to the terminal in INACTIVE state. If other user states similar to IDLE state are present in the network, processing may be performed analogously, and details will not be described herein.

If the terminal in IDLE or INACTIVE state does not need to receive, transmit, measure, or perform other actions on any signal, the terminal may be in a sleep state to reduce power consumption. According to different channel conditions, services required to be processed, or the like, the terminal may be in different sleep modes. For example, the terminal enters a light sleep mode for transient dormancy in which a new signal needs to be processed within a short time. As another example, the terminal enters a deep sleep mode used when no new signal needs to processed within a long time, and the deep sleep mode may reduce more power consumption of the terminal than the light sleep mode. Generally, when no service function is affected, allowing the terminal to be in the sleep mode can effectively reduce power consumption of the terminal, thereby improving user experience.

Upon or before the terminal receives a data signal, some preprocessing is often required. For example, the terminal may make an automatic gain control (AGC) parameter adjustment, so that a received signal can be adjusted to be within a suitable dynamic range, so as to achieve improved reception performance. Alternatively, the terminal needs to perform time-frequency tracking, and estimate a time deviation or frequency deviation parameter or the like of a signal according to a reference signal, so that the time-frequency parameter is consistent with the base station or an accurate channel parameter can be acquired, or the like, thereby performing corresponding correction on the signal or data to be processed, to achieve improved reception performance. The terminal may also perform some other processing to optimize data processing, improve user experience, and so on, and details will not be described herein again. The network may configure and transmit a reference signal to the terminal. The reference signal is used for channel measurement, channel parameter estimation, mobility assessment, spatial parameter estimation, and the like of the terminal, thereby implementing functions such as radio resource management and reception of auxiliary data and signals. For example, the terminal may receive a synchronization reference signal transmitted by the network, make an AGC adjustment, estimate a time-frequency parameter, or the like. Due to various internal or external factors, the number of times or duration the terminal needs to wake up from the dormant mode are different when the terminal performs the foregoing preprocessing. For example, when the channel condition is poor and hence the reception quality of the related reference signal is poor, or when the processing capability of the terminal is limited, the terminal needs to be woken up a plurality of times to receive a plurality of reference signals, so as to achieve improved reception performance. As another example, the configured reference signal is far from the signal to be received, and the terminal may also need to receive the reference signal a plurality of times or maintain a long active time, so as to achieve improved reception performance.

The user terminal in IDLE state or INACTIVE state may utilize a synchronization signal in an SSB to implement related AGC or time-frequency parameter estimation. The period and the time-frequency location of the SSB are typically fixed, and may not be capable of meeting the requirements of different users to receive signals and reduce power consumption. Therefore, the network may provide an additional reference signal for reception performed by the terminal, so that the terminal can acquire the required parameter or information faster, thereby reducing the time or number of times of wake-up, and achieving a better power saving effect.

The network may configure CSI-RS signals to be used as reference signals of an IDLE or INACTIVE user. For example, the network configures several not-zero-power periodic CSI-RS signals in system broadcast information to serve as reference signals of an IDLE or INACTIVE user. To reduce power consumption of the network, the network may share CSI-RS signals transmitted to a user in the connected state with a user in IDLE state for use. If the user in the connected state no longer uses these resources, or if the network needs to reduce power consumption of transmission, the network may partially or completely turn off the foregoing CSI-RS signals according to different situations.

The user terminal in IDLE state or INACTIVE state may determine one or more CSI-RS resources and corresponding transmission occasions according to an indication of the network. Whether CSI-RS signals are actually transmitted on the CSI-RS transmission occasions may be controlled by the network. The network device may activate or stop transmission of some signals according to adjustment by the user in the connected state or network power consumption reduction or other causes. In this case, the user in IDLE state needs to be informed of the state update of the used CSI-RS, so that the user in IDLE state can correctly receive the CSI-RS signal. The network device may transmit an indication to indicate the availability state of the configured CSI-RS resource in one or more transmission occasions. When a transmission occasion of a CSI-RS is indicated as available, the terminal may receive the signal on the transmission occasion, so as to use the signal to achieve the purpose of reducing power consumption. When the CSI-RS is configured to be a periodic signal, several transmission occasions are present in the time domain. In order to simplify description, the related action of indicating the availability of a CSI-RS signal on one or more transmission occasions may also be simply referred to as indicating the availability or unavailability of the CSI-RS signal or the availability or unavailability of a CSI-RS resource. The foregoing descriptions may all be understood as indicating whether CSI-RS signals are transmitted on one or more transmission occasions determined by a corresponding CSI-RS resource.

The terminal in IDLE state or INACTIVE state needs to periodically receive information of the network, such as paging information, a SIB updating message, etc. The terminal in IDLE state or INACTIVE state may use a discontinuous reception (DRX) mode to receive a paging message of the network so as to reduce power consumption. That is, in one paging DRX period, the terminal only wakes up and performs reception for a portion of the time. For example, the terminal determines the position of a paging occasion in each paging cycle period according to a parameter configured by the network, monitors a paging PDCCH on a paging PDCCH monitoring occasion related to the paging occasion, and performs a further action according to content indicated in the paging PDCCH. For example, the terminal can determine, according to network configurations, a paging cycle period parameter T and a paging frame (PF) parameter N for receiving a paging message. One paging frame is one radio frame, and may include one or more paging occasions (POs) or the start of one PO. To simplify description of the relationship between a PF and a PO, it can be said that one PF corresponds to and is associated with one or more POs, or one PF includes one or more POs. Similarly, a certain PF may also be referred to as a PF of one PO. One paging occasion consists of several paging PDCCH monitoring occasions (MOs). When a plurality of beams are used to perform transmission in the network, different MOs may correspond to different beams, so that terminals in different locations can all obtain improved downlink reception. For example, the terminal determines that N paging frames are present in one paging cycle having a length of T radio frames, and determines that one of the N paging frames is a paging frame in which the terminal needs to detect paging information. When one paging frame includes a plurality of POs, the terminal determines, according to a rule and a parameter, that one of the plurality of POs is a PO of the terminal. The terminal may then select an MO in the PO to receive a PDCCH. For example, one or more certain MOs are selected according to beam information to detect a paging PDCCH. If the terminal detects a valid paging PDCCH, the terminal performs paging PDSCH reception or another related action according to detected DCI.

In a specific example, the terminal may acquire, according to a TMSI or an IMSI of a user, a parameter UE_ID for determining a paging occasion. The TMSI of a terminal typically has a relatively large number of bits. For example, a 5G-S-TMSI has 48 bits. A certain operation may enable terminals having different TMSIs to correspond to the same UE_ID, thereby simplifying paging design. For example, by means of the 5G-S-TMSI of the terminal, it is determined that UE_ID=5G-S-TMSI mod 1024, where mod is the modulo operation.

Furthermore, the terminal acquires, according to a parameter configured by the network, a frame number SFN of a PF corresponding to a PO that the user needs to monitor, and the frame number SFN satisfies the following condition:

$$( SFN + PF\_offset ) mod T = ( T / N ) * ( UE\_ID mod N )$$

where PF_offset is a paging frame offset value configured by the network, and T is a paging cycle period determined by the terminal. N is the number of paging frames in one paging cycle period. mod is the modulo operation.

The terminal determines the frame number of the paging frame (PF), and then determines the PO that needs to be monitored. Depending on different network configurations, one PF may be associated with a plurality of POs. The UE needs to determine one specific PO among the plurality of POs that is monitored to monitor a related PDCCH to determine whether a corresponding paging message and the like is present. For example, the terminal may determine, according to a sequence number i_s of the PO related to the PF, the PO that the terminal needs to monitor.

$$i\_s = floor ( UE\_ID / N ) mod Ns$$

where Ns is configured by the network, and is the number of POs corresponding to one PF. floor is a rounding down operation.

After the terminal determines the sequence number of the PO, the terminal may determine information of each monitoring occasion (MO) according to a paging search space set parameter configured by the network. For example, the terminal may determine, starting from a PF radio frame and according to a search space set configuration and a CORESET configuration of a paging PDCCH, the sequence number of the PO associated with the PF and S*X consecutive MOs of the PO. S is the number of SSBs actually transmitted in one SSB period in the network, and may be determined, for example, by means of parameter ssb-PositionsInBurst in SIB1. The value of X is 1 by default, and may be configured by a higher layer. Every S MOs of the PO are respectively associated with S different SSB sequence numbers, that is, respectively satisfying a QCL relationship according to the order of the SSB sequence numbers.

According to a related method, the terminal may perform paging PDCCH monitoring on the determined MOs. The DCI in the paging PDCCH includes some information, for example, for indicating whether a user has a corresponding paging message that needs to be received. If there is a paging message to be received, PDSCH resource parameters for transmitting the paging message are further indicated in the DCI, including parameters such as a time domain resource, a frequency domain resource, a modulation means, etc. The terminal may receive a paging PDSCH according to the indication.

To reduce power consumption, the terminal in IDLE state typically operates in a DRX state. When the terminal does not receive data, the terminal enters a dormant state. When the terminal receives data, the terminal needs to satisfy a state of time-frequency synchronization with the base station, so as to ensure correct transmission of the data. When the terminal operates, there may be a time-frequency difference between the terminal and the base station. Particularly in the dormant state, continuous accumulation of small differences may result in a large difference, resulting in the terminal no longer being synchronized with the base station. The terminal may perform time-frequency tracking by receiving an SSB, so as to be accurately synchronized with the base station. Therefore, when performing PO monitoring, the terminal needs to be woken up in advance, and receive a plurality of SSBs, so that the terminal is synchronized with the network in time and frequency. If DCI detected by the terminal in a PO indicates that there is no paging data reception, the terminal may re-enter the dormant mode to reduce power consumption.

The network may transmit an indication before the terminal performs PO monitoring, so as to indicate whether the terminal needs to perform PO monitoring in one or more paging cycles. The indication may be referred to as a paging early indication (PEI), or may have other names. Hereinafter, PEI may be uniformly used to refer to all related information. For example, when paging information in the network needs to be received by the terminal, the network transmits a PEI indication to indicate that the terminal needs to monitor a corresponding PO. The terminal is woken up before the PO, performs time-frequency synchronization, and monitors a paging PDCCH and receives a possible PDSCH on the determined PO. If the PEI indication received by the terminal indicates that the terminal does not need to monitor a PO, then the terminal does not need to perform monitoring on the corresponding PO, and does not need to be woken up and receive an SSB before the PO to perform time-frequency synchronization to prepare for possible PDSCH reception. In this way, the terminal can avoid, by means of the indication of the network, unnecessary actions such as waking up, synchronization, etc., thereby reducing power consumption of the terminal.

The PEI indication may be transmitted in the form of DCI by using a PDCCH channel, and may also be denoted as PEI-DCI. The network configures a search space set and a CORESET parameter used by a PEI-PDCCH, and the terminal determines time-frequency resources related to the PEI-PDCCH according to the configuration. The PEI-PDCCH may use configurations similar to those of the paging PDCCH. For example, the terminal may determine, according to configurations of the PEI-PDCCH, several PEI occasions (PEI-O) and several PEI-PDCCH monitoring occasions (PEI-MO) related to the PEI occasions. Respective PEI-MOs of one PEI occasion may satisfy QCL with respect to different SSB sequence numbers, so as to cover users in different directions within the cell. Several PEI occasions may be present in one DRX cycle, and the network transmits indications to different terminals on these PEI occasions. To reduce power consumption, the terminal does not perform PEI-PDCCH monitoring on all PEI occasions, so that the terminal needs to determine which PEI occasions to monitor. That is, the terminal determines the correspondence relationship between PEI occasions and a PO monitored by the terminal, so that the terminal can correctly receive a PEI-PDCCH and acquire, from demodulated PEI-DCI, a PEI indication indicating whether the UE monitors the corresponding PO. One piece of PEI information can indicate reception of a plurality of POs. That is, terminals monitoring different POs can monitor the same PEI occasion to acquire PEI-DCI, and the PEI-DCI includes an indication related to different POs. The number of POs corresponding to one piece of PEI information may be referred to as the capacity of the PEI. Depending on the described purposes, the number of POs corresponding to one piece of PEI information may also be referred to as the capacity of a PEI occasion or the capacity of PEI-DCI or the like.

In addition to indicating whether the terminal in IDLE or INACTIVE state needs to monitor for a related PO, bits in the PEI-DCI can further indicate the availability of CSI-RSs for reception by the terminal in IDLE or INACTIVE state before the PO or during the PF. If the terminal is instructed to monitor for a related PO, the availability of CSI-RS signals can be determined according to a related indication. The terminal may use these CSI-RS signals to achieve improved time-frequency synchronization or to acquire more sleep time, thereby improving performance of the terminal or reducing power consumption of the terminal. The terminal needs to determine a duration corresponding to the availability of CSI-RS signals indicated by the PEI, for example, to determine a starting position and a duration, so that the availability of several CSI-RSs in this period of time is determined by a related indication field in the PEI. In this way, the terminal can determine CSI-RS occasions on which CSI-RS signals can be used by the terminal, thereby achieving a related purpose. Additionally, the terminal further needs to determine the mapping relationship between availability bits indicated in the PEI-DCI and CSI-RS resources, so as to determine the availability of a specific CSI-RS resource. The method and procedure used in the present invention are described below with reference to specific embodiments.

### Embodiment 1

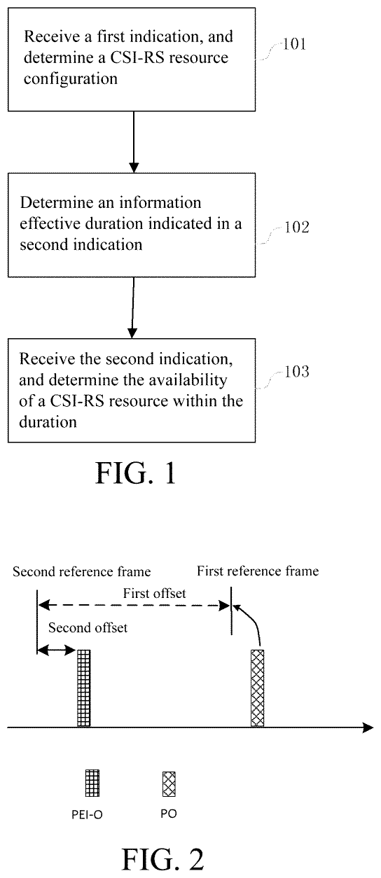

FIG. 1 is a flowchart showing a method performed by user equipment according to an embodiment of the present invention.

As shown in FIG. 1, in step 101, a terminal receives a first indication, the first indication indicating a CSI-RS resource configuration configured in a network and to be used by a user in IDLE state or INACTIVE state.

Then, in step 102, a CSI-RS resource availability duration indicated in a second indication is determined, the duration including a starting point and a length.

In step 103, the second indication is received, and the availability of at least one CSI-RS resource to be used by the user in IDLE state or INACTIVE state is determined.

Related procedures are specifically exemplified below, respectively.

The terminal in IDLE state or INACTIVE state receives the first indication in a system broadcast, and can determine that the network is configured with several CSI-RS resources that can be used for assistance in reception of paging information. Via the foregoing configuration information, the terminal can acquire a CSI-RS resource duration, symbols and frequency positions, etc., and determine transmission occasions of a CSI-RS signal in the time domain. The terminal needs to determine the availability of these transmission occasions according to an indication by the network.

The terminal may receive the second indication to determine the availability of the transmission occasions. The second indication is in PEI-DCI information transmitted by the network, and is used to indicate CSI-RS availability. The terminal determines, according to the detected PEI-DCI information, an indicated information effective duration.

The terminal may determine, according to a paging parameter, a PO that needs to be monitored in one paging cycle. When the terminal can receive the PEI-DCI information to determine a paging reception indication, the terminal determines the location, in one paging cycle, of a PEI occasion associated with a PO that needs to be monitored. For example, first, the location of a first reference frame associated with the PO is determined according to UE_ID of the terminal. The terminal determines, according to a first offset value relative to the first reference frame, the location of a second reference frame, and the location of a starting symbol of a PEI occasion at a second offset relative to the location of the second reference frame. The terminal determines, from the starting location, several PEI-PDCCH monitoring occasions, and monitors PEI-DCI transmitted on the PEI occasion. The first offset value and the second offset value may be configured by a higher layer. For example, the first offset value is several radio frames, and the second offset value is several symbols. One reference frame is as shown in FIG. 2.

In this way, the terminal can determine a PO that needs to be monitored in one paging cycle and a time-frequency location of a PEI occasion corresponding to the PO. Further, the terminal can determine CSI-RS resource availability information indicated in PEI-DCI transmitted on the PEI occasion.

In an optional embodiment, the CSI-RS availability indication in the PEI-DCI indicates several POs associated with the PEI occasion and the availability of the CSI-RS signal. One PEI occasion may be associated with a plurality of different POs, and these POs are respectively monitored by different (groups of) terminals. The different terminals need to determine related PEI occasions and CSI-RS availability information, respectively.

Optionally, one PEI-DCI includes a set of CSI-RS availability indications, and the terminals detecting the PEI use the same CSI-RS availability indication to determine the CSI-RS availability.

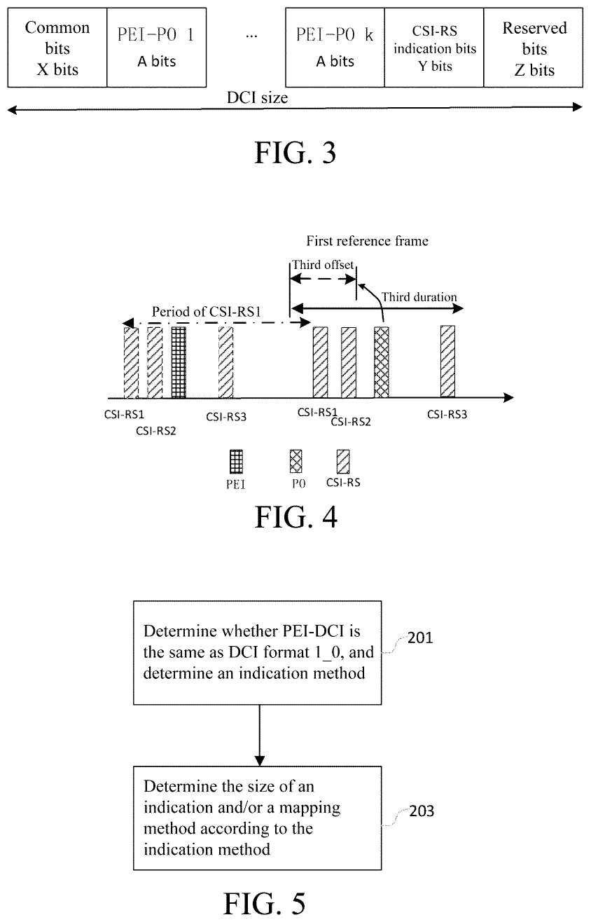

A specific example is as shown in FIG. 3. One PEI occasion corresponds to k different POs, so that k*A bits are used in the PEI-DCI to indicate PEI information of the related POs. Each PEI-PO is PEI information used by the terminal instructed to monitor the PO, and is represented by A bits. A is the number of groups of different terminals in one PO, and k is the number of POs associated with one PEI occasion. Y bits are used in the PEI-DCI to indicate the availability of the related CSI-RS, and are used by terminals monitoring the POs to determine a corresponding CSI-RS transmission situation. Several common bits or reserved bits may also be present in the PEI-DCI, and are used to indicate other content. The order of respective bit portions in DCI is not unique, and may be determined according to specific specifications, which is not described in detail herein.

After determining the CSI-RS availability indication in the PEI-DCI received on the monitored PEI occasion, the terminal further needs to determine an application duration of the indication, i.e., which CSI-RS transmission occasions the foregoing bits correspond to in terms of availability.

Optionally, the terminal determines the starting point of the CSI-RS availability indication duration. The terminal determines that the starting point is an offset of O time units from the first reference frame used by the terminal to determine the PEI. Optionally, the offset value O may be configured by a higher layer, and the value O is 0 by default if the higher layer does not configure said parameter. The unit of O may be a time unit used in the network, for example, a slot, or a radio frame, or a millisecond, or the like.

Optionally, the terminal uses the first offset value used to determine the PEI occasion as the value of O. Optionally, the terminal uses a difference between the first offset value and the second offset value used to determine the PEI occasion as the value of O. When the difference is used, if the offset values are indicated by using different time units, it is necessary to consider conversion between the different units, which is not described in detail herein.

Optionally, the terminal determines the length of the CSI-RS availability indication duration in the PEI-DCI. The terminal may determine, according to the number of POs associated with the PEI occasion, the number of PFs corresponding to the PEI occasion. The terminal determines the length of the CSI-RS availability indication duration according to the number of PFs and the offset value O. The terminal may determine, according to a configuration, the number D of POs indicated by one PEI occasion, and the terminal may determine, according to a higher layer configuration, the number Ns of POs corresponding to each paging frame in the network. The terminal may determine the number M of PFs corresponding to the PEI occasion. When D is greater than or equal to Ns, M=D/Ns. When D is less than Ns, M=1. The terminal determines M*(T/N) consecutive radio frames according to M, where T is the number of radio frames of the paging cycle determined by the terminal, and N is the number of paging frames in one paging cycle determined by the terminal. The terminal determines, according to the offset value O of the CSI-RS availability indication duration, that the length of the indication duration is O+M*(T/N) radio frames. Optionally, a parameter X is used to adjust the value O to use different units, for example, the length is O+M*(T/N)*X. X is a parameter for unifying the unit of O and the unit of the length of the radio frame. When O is expressed by using the number of radio frames, X=1, and the unit of the acquired length is also the number of radio frames. When O is expressed by using the number of slots, X is determined by a subcarrier parameter of a downlink BWP in which the PF indicated by the PEI is located, and the unit of the acquired length is also the number of slots. For example, when the BWP uses a 15 kHz subcarrier parameter, one radio frame corresponds to ten slots, and in this case X=10. When other units are used for expression in the system, the value of X may also be acquired in a similar manner.

A specific example is as shown in FIG. 4. The network configures three CSI-RS resources for reception by a terminal in IDLE state. The terminal may determine, according to parameters of each resource such as the period and the offset parameter, respective transmission occasions of the CSI-RS resources in a slot. For example, FIG. 4 shows two transmission occasions of the CSI-RS1/2/3 in the time domain. The terminal determines the indication duration of the CSI-RS indication in the PEI-DCI, for example, determines that the indication duration is a third duration according to the starting point and the length. The terminal determines the availability of each CSI-RS transmission occasion in the third duration according to the indication in the PEI-DCI. For example, in the indication in the PEI-DCI, a bitmap is used to respectively indicate the availability of each CSI-RS. The terminal determines, according to the configuration, that CSI-RS1 corresponds to a first bit in the bitmap, CSI-RS2 corresponds to a second bit in the bitmap, and CSI-RS3 corresponds to a third bit in the bitmap. In the indication, the bit 1 is used to indicate that a CSI-RS signal transmission is present on the CSI-RS transmission occasion, and the bit 0 is used to indicate that no CSI-RS signal transmission is present on the CSI-RS transmission occasion. In this way, the terminal can determine a transmission situation of each CSI-RS resource according to the CSI-RS indication in the PEI-DCI. For example, the bitmap indicates 110, and the terminal can determine that an actually transmitted CSI-RS signal is present on the transmission occasions of CSI-RS1 and CSI-RS2 within the third duration, and that no actually transmitted signal is present on the transmission occasions of CSI-RS3. The terminal may thus determine a corresponding reception scheme according to the signal transmission situation, and achieve a corresponding purpose.

In an optional embodiment, a paging PDCCH may also be used in the network to indicate the availability of a CSI-RS resource. For example, the terminal receives an indication in a paging PDCCH, and determines the availability of CSI-RS resources in several default paging cycles starting from an SFN determined in a position where the paging information is received. In this case, if the duration determined by the terminal according to the CSI-RS availability information in the PEI-DCI overlaps with the duration determined by the terminal according to the CSI-RS availability information in the paging PDCCH, the terminal needs to determine which indication is valid in the overlapping duration.

Optionally, in a common indication duration, when the CSI-RS availability information determined by the terminal according to the PEI-DCI is inconsistent with the information determined by the terminal according to the paging PDCCH, the terminal determines the validity of the CSI-RS in the duration according to the information indicated by the PEI-DCI. That is, in the common duration, the indication in the PEI-DCI is prioritized over the indication in the paging PDCCH. Optionally, the terminal does not expect to receive the CSI-RS availability indication in the PEI-DCI, and the CSI-RS transmission occasion that is determined to be available according to the indication of the paging PDCCH in the determined duration is indicated to be unavailable in the indication in the PEI-DCI. The indication duration of the CSI-RS availability information in the paging PDCCH is typically long, so that via this method, the terminal can more quickly acquire the transmission status of the CSI-RS reference signal required by the current paging and monitoring, thereby better improving terminal performance.

### Embodiment 2

CSI-RS resource availability may be indicated via physical layer signaling in a network. For example, indication is performed via some bits in a paging early indication (PEI). Several CSI-RS resources or resource sets may be configured in the network to be used for reception by a terminal in IDLE or INACTIVE state. The terminal needs to determine a method for mapping a CSI-RS availability indication bit field to a CSI-RS resource, that is, to determine a resource(s) or resource set of which the availability is indicated by a certain availability indication bit in received PEI-DCI, thereby enabling accurate signal reception. When the network uses PEI-DCIs of different sizes, it may be possible to use different mapping methods. For example, when the number of bits available for a CSI-RS resource availability indication in the PEI-DCI is large, the terminal determines a correspondence relationship between a CSI-RS resource and an indication bit in the DCI according to a first method, and when the number of bits available for a CSI-RS resource availability indication is small, the terminal determines a correspondence relationship between a CSI-RS resource and an indication bit in the DCI according to a second method. The terminal needs to determine the size of the bit field for a CSI-RS availability indication in the DCI, and determine a corresponding mapping method.

FIG. 5 is a flowchart showing a method performed by user equipment according to another embodiment of the present invention.

As shown in FIG. 5, in step 201, a terminal determines whether the size of PEI-DCI is the same as that of DCI format 10, and determines a corresponding indication method.

In step 203, the terminal determines, according to the indication method, the size of a CSI-RS indication in the PEI-DCI and/or a mapping method.

Detailed description of the steps in the present embodiment is provided below.

In NR, DCI that is carried needs to be scrambled by using a specific sequence in a PDCCH generation procedure. For example, a CRC portion is scrambled by using a 16-bit RNTI. The terminal may perform blind detection and descrambling on a received PDCCH signal by using a specific RNTI, and verify the correctness of the CRC. If the PDCCH signal can be correctly descrambled and successfully verified, the terminal can acquire a related DCI indication; otherwise, the terminal discards the related signal. In this way, the terminal can identify signaling having the same DCI size but scrambled by using a different RNTI.

A network uses PEI-DCI to carry a CSI-RS resource availability indication to indicate whether an available CSI-RS signal is present in a corresponding duration for reception by a user. PEI-DCI information is transmitted by using a PDCCH channel, and the network may use different configuration methods to satisfy different requirements. For example, the network configures a PDCCH search space of the PEI to be the same as a search space for a paging PDCCH and use the same DCI size, so as to reduce blind detection overhead of the terminal. In this case, the network needs to configure an RNTI (e.g., a PEI-RNTI) different from a P-RNTI used by the paging PDCCH, so that the terminal can distinguish between different DCI information. In this case, the maximum number of bits available for a CSI-RS availability indication in the PEI-DCI may be large, for example, as large as the maximum number of bits of the DCI of the paging PDCCH for a CSI-RS availability indication. In another case, to improve the reception reliability of a PEI signal or to enhance downlink reception capability for the PEI signal, etc., a small number of bits of the PEI-DCI is used, and in this case, a small number of bits may also be used in the PEI-DCI to indicate CSI-RS availability. When the PEI-DCI uses a different scheme to indicate the CSI-RS availability, a different mapping relationship is present between a related indication bit and a CSI-RS resource or resource set configured in a SIB, and the terminal needs to determine a mapping relationship between the CSI-RS availability indication in the PEI-DCI and the CSI-RS resource or resource set, so as to determine the availability of the indicated CSI-RS resource.

Optionally, the terminal determines, according to the size of the PEI-DCI, the number of bits for the CSI-RS availability indication and/or a method of mapping between these bits and the CSI-RS resource. Specifically, when the size of the PEI-DCI is the same as the size of DCI format 1_0, the terminal uses a first method to determine the number of CSI-RS availability indication bits in the PEI-DCI and a method of mapping between the bits and the CSI-RS resource. When the size of the PEI-DCI is smaller than the size of DCI format 1_0, the terminal uses any one of second/third/fourth methods to determine the number of CSI-RS availability indication bits in the PEI-DCI and a method of mapping between the bits and the CSI-RS resource.

To reduce indication overhead, the network may configure a group number for a CSI-RS resource set configured for a user in IDLE or INACTIVE state. When the number of CSI-RS resources is large, it is possible that different CSI-RS resources or resource sets use the same group number. When the terminal determines that the first method is used to determine the number of CSI-RS availability indication bits and the method of mapping between the bits and the CSI-RS resource, the terminal determines, according to the value of bits corresponding to the maximum group number configured in system information for the CSI-RS resource sets, the number of bits for a CSI-RS availability indication, and determines, according to the group number of the CSI-RS resource set, bits in the indication corresponding to CSI-RS resources in the CSI-RS resource set. For example, when the group number is counted from 0, the terminal determines that the number of CSI-RS indication bits is the maximum group number plus 1, and the terminal determines that an indication bit corresponding to the group number is the n-th bit in the availability indication bits, n being the group number plus 1. In this way, the terminal can determine the position of the indication bit according to the group number of the CSI-RS resource, and acquire a corresponding indication of a transmission occasion for the CSI-RS resource.

Optionally, when the terminal determines that the second method is used to determine the number of CSI-RS availability indication bits and the method of mapping between the bits and the CSI-RS resource, the terminal determines that the number of bits for a CSI-RS availability indication in the PEI-DCI is one, and the terminal determines that the availability bit indicates the availability of a CSI-RS resource using the same QCL reference signal as a PDCCH monitoring occasion of the received PEI-DCI.

Optionally, when the terminal uses the third method to determine the number of CSI-RS availability indication bits and the method of mapping between the bits and the CSI-RS resource, the terminal determines that the number of bits for a CSI-RS availability indication in the PEI-DCI is N. N is configured by a higher layer, and is the maximum number of CSI-RS resource sets used for reception by a user in IDLE state or an activated state and using the same QCL reference signal. The terminal acquires a CSI-RS indication bit according to the order of group IDs of CSI-RS resource sets having the same QCL reference signal.

Optionally, when the terminal uses the fourth method to determine the number of CSI-RS availability indication bits and the method of mapping between the bits and the CSI-RS resource, the terminal determines that the number of bits for a CSI-RS availability indication in the PEI-DCI is one. The terminal determines, according to group IDs of CSI-RS resource sets having the same QCL reference signal, several CSI-RS resource sets using the same group ID, and the terminal determines that the availability indication bit is used to indicate the availability of CSI-RS resources in the several CSI-RS resource sets.

In a specific example, the network configures three CSI-RS resource sets, and each resource set includes four CSI-RS resources. A configuration group number in a CSI-RS resource set 1 is 0, and a CSI-RS resource therein uses SSB0 as a QCL reference signal. A configuration group number in a CSI-RS resource set 2 is 1, and a CSI-RS resource therein uses SSB1 as a QCL reference signal. A configuration group number in a CSI-RS resource set 3 is 2, and a CSI-RS resource therein uses SSB2 as a QCL reference signal. When the terminal determines that the first method is used to indicate CSI-RS resource availability, the terminal determines that the number of CSI-RS availability indication bits in PEI-DCI is three, and the respective bits sequentially correspond to the availability of resources in the CSI-RS resource set 1/2/3. When the terminal determines that the second method is used to indicate CSI-RS resource availability, the number of CSI-RS availability indication bits in PEI-DCI received in a PEI-PDCCH satisfying QCL with respect to SSB1 is one, and the bit indicates the availability of the CSI-RS resource using SSB1 as the QCL reference signal, i.e., the resource in the CSI-RS resource set 2.

In another specific example, the network configures three CSI-RS resource sets, and each resource set includes four CSI-RS resources. A configuration group number in a CSI-RS resource set 1 is 0, and a CSI-RS resource therein uses SSB0 as a QCL reference signal. A configuration group number in a CSI-RS resource set 2 is 1, and a CSI-RS resource therein uses SSB1 as a QCL reference signal. A configuration group number in a CSI-RS resource set 3 is 2, and a CSI-RS resource therein uses SSB1 as a QCL reference signal. When the terminal determines that the third method is used to indicate CSI-RS resource availability, and N configured by the higher layer is greater than one, the terminal determines that the number of CSI-RS availability indication bits in PEI-DCI is N. The terminal indicates, in an indication in PEI-DCI received in a PEI-PDCCH satisfying QCL with respect to SSB1, the availability of the CSI-RS resources using SSB1 as the QCL reference signal, i.e., the resources in the CSI-RS resource sets 2 and 3. In the N indication bits, a first bit indicates the availability of the resource in the CSI-RS resource set 2, and a second bit indicates the availability of the resource in the CSI-RS resource set 3.

Optionally, the terminal determines, according to the size of the PEI-DCI, the CSI-RS availability bits in the PEI-DCI and/or a method of mapping between these bits and the CSI-RS resource. When the size of the PEI-DCI is smaller than the size of DCI format 1_0, if the number of remaining bits in the PEI-DCI excluding a PEI-PO indication and common information is less than the number of CSI-RS resource set groups configured by the network, the terminal uses one of the second/third/fourth methods to determine the number of CSI-RS availability indication bits and a method of mapping between the bits and the CSI-RS resource. When the number of the remaining bits is greater than the number of CSI-RS resource set groups configured by the network, the terminal uses the first method to determine the number of CSI-RS availability indication bits and the method of mapping between the bits and the CSI-RS resource. In a specific example, the network configures the size of the PEI-DCI to be M. The terminal may determine, according to the size A of each PEI-PO and a PEI capacity D and the determined number X of bits of the other portion, that the number of the remaining bits of the PEI-DCI is Y=M−(A*D+X). The terminal may determine, according to the value of Y, information such as the size of CSI-RS resource availability in the PEI information, the mapping method, etc.

### Embodiment 3

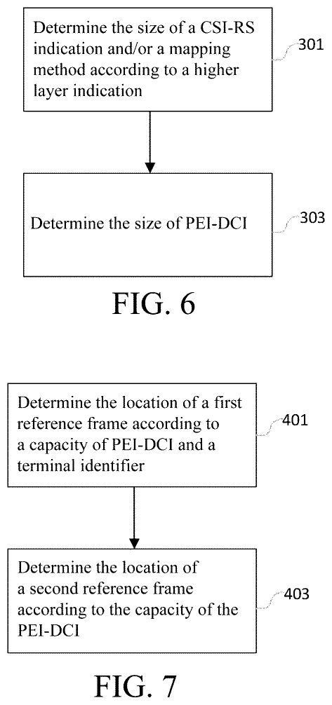

FIG. 6 is a flowchart showing a method performed by user equipment according to another embodiment of the present invention.

As shown in FIG. 6, in step 301, a terminal determines, according to a higher layer indication, the size of a CSI-RS indication in PEI-DCI and/or a mapping method.

In step 303, the terminal determines the size of the PEI-DCI.

In NR, DCI that is carried is scrambled by using a specific sequence in a PDCCH generation procedure. For example, a CRC portion is scrambled by using a 16-bit RNTI. The terminal may perform blind detection and descrambling on a received PDCCH signal by using a specific RNTI, and verify the correctness of the CRC. If the PDCCH signal can be correctly descrambled and successfully verified, the terminal can acquire a related DCI indication; otherwise, the terminal discards the related signal. In this way, the terminal can identify signaling having the same DCI size but scrambled by using a different RNTI.

A network uses PEI-DCI to carry a CSI-RS resource availability indication to indicate whether an available CSI-RS is present in a corresponding duration for reception by a user. PEI-DCI information is transmitted by using a PDCCH channel, and the network may use different configuration methods to satisfy different requirements. For example, a PDCCH search space of the PEI is configured to be the same as a search space for a paging PDCCH, and the same DCI size is used to reduce blind detection overhead of the terminal. In this case, the network needs to configure an RNTI, (e.g., a PEI-RNTI) different from a P-RNTI of the paging PDCCH, so that the terminal can distinguish between different DCI information. In this case, the maximum number of bits available for a CSI-RS availability indication in the PEI-DCI may be large, for example, as large as the maximum number of bits of the DCI of the paging PDCCH for a CSI-RS availability indication. In another case, to improve the reception reliability of a PEI signal or to enhance downlink reception capability for the PEI signal, etc., a small number of bits of the PEI-DCI is used, and in this case, a small number of bits is also used in the PEI-DCI to indicate CSI-RS availability. When the PEI-DCI uses a different scheme to indicate the CSI-RS availability, a different mapping relationship is present between a related indication bit and a CSI-RS resource or resource set configured in a SIB, and the terminal needs to determine a mapping relationship between the CSI-RS availability indication in the PEI-DCI and the CSI-RS resource or resource set, so as to determine the availability of the indicated CSI-RS resource.

The terminal may determine the CSI-RS availability indication and/or a mapping relationship between the indication and the CSI-RS resource or resource set in the PEI-DCI according to a higher layer indication.

In an optional embodiment, the terminal determines, according to the RNTI used by the PEI-DCI, the method of mapping between the CSI-RS availability indication and the CSI-RS in the PEI-DCI. When the PEI-DCI is scrambled by using the RNTI different from the P-RNTI, a first method is used in the PEI-DCI to determine the number of CSI-RS availability indication bits and the method of mapping between the bits and the CSI-RS resource. When the PEI-DCI is scrambled by using the P-RNTI, one of second/third/fourth methods is used in the PEI-DCI to determine the number of CSI-RS availability indication bits and a method of mapping between the bits and the CSI-RS resource.

Optionally, the terminal determines the number of CSI-RS availability indication bits in the PEI-DCI according to the RNTI, thereby determining the size of the PEI-DCI. In a specific example, for the size of the PEI-DCI, according to the size A of each PEI-PO, a PEI capacity k, the number Y of CSI-RS availability indication bits, and the determined number X of bits of other portions, the terminal can determine that the size of the PEI-DCI is A*k+X+Y. Optionally, the size of the PEI-DCI has a minimum value Z, for example, Z=12, so that the terminal can determine that the size of the PEI-DCI is max(A*k+X+Y, Z). The max operation is to acquire a larger one of two values. The terminal determines the size of the PEI-DCI, and uses the same for reception of PEI information.

In an optional embodiment, the terminal determines, according to a higher layer indication, the method of mapping between the CSI-RS availability indication and the CSI-RS in the PEI-DCI. For example, the higher layer uses one bit to indicate the CSI-RS availability bits and/or the method of mapping between these bits and the CSI-RS resource in the PEI-DCI. For example, when the higher layer indication is 1, the terminal uses one of the second/third/fourth methods to determine the number of CSI-RS availability indication bits and the method of mapping between the bits and the CSI-RS resource; otherwise, the terminal uses the first method to determine the number of CSI-RS availability indication bits and the method of mapping between the bits and the CSI-RS resource.

Optionally, after determining the number of CSI-RS availability indication bits in the PEI-DCI according to the higher layer indication, the terminal may further the size of the PEI-DCI. Specifically, for the size of the PEI-DCI, according to the size A of the PEI-PO, the PEI capacity k, the number Y of CSI-RS availability indication bits, and the determined number X of bits of other portions, the terminal can determine that the size of the PEI-DCI is A*k+X+Y. Optionally, the size of the PEI-DCI has a minimum value Z, for example, Z=12. Therefore, the terminal can determine that the size of the PEI-DCI is max(A*k+X+Y, Z). The max operation is to acquire a larger one of two values. The terminal determines the size of the PEI-DCI, and uses the same for reception of PEI information.

### Embodiment 4

FIG. 7 is a flowchart showing a method performed by user equipment according to another embodiment of the present invention.

As shown in FIG. 7, in step 401, a terminal determines the location of a first reference point according to a capacity of a PEI and a terminal identifier.

In step 403, the terminal determines a second reference frame according to the capacity of the PEI.

Detailed description of the steps in the present embodiment is provided below.

The terminal may determine, according to a paging parameter, a PO that needs to be monitored in one paging cycle. When the PEI is used to implement a paging reception indication, the terminal determines the location of a PEI occasion associated with a PO that needs to be monitored in one paging cycle, and for example, determines, according to UE_ID of the terminal, the location of a first reference point associated with the PO. The terminal determines, according to a first offset value relative to the first reference point, the location of a second reference point corresponding to the PO, and a starting position of a PEI occasion at a second offset relative to the location of the second reference point. The first offset value and the second offset value may be configured by a higher layer. For example, the first offset value is several radio frames, and the second offset value is several symbols.

The terminal determines the location of a first reference frame of the terminal in one paging cycle according to UE_ID and a capacity of the PEI occasion. Optionally, when the capacity D of the PEI occasion is less than or equal to Ns, the terminal determines that the number of POs corresponding to one PEI occasion is less than or equal to the number of corresponding POs in one PF. The terminal may acquire, according to a TMSI of a user, parameter UE_ID for determining a paging occasion, for example, UE_ID=5G-S-TMSI mod 1024. Before the terminal acquires a related user identifier, UE_ID=0 can be used. The terminal acquires, according to UE_ID, the value of a reference ID: ref_ID=(UE_ID mod N), and then the terminal acquires a frame number ref_SFN of a first reference radio frame that satisfies the following condition:

$$( ref\_SFN + PF\_offset ) mod T = ( T / N ) * ref\_ID$$

Optionally, when the capacity D of the PEI is greater than Ns, the terminal determines that the number of POs corresponding to one PEI occasion is greater than the number of corresponding POs in one PF. The terminal may acquire, according to a TMSI of a user, the parameter UE_ID for determining a paging occasion, and acquire the value of ref_ID according to UE_ID: ref_ID=F*floor((UE_ID mod N)/F), where F=D/Ns, i.e., the number of PFs corresponding to one PEI occasion. The terminal may acquire the frame number ref_SFN of the first reference radio frame that satisfies the following condition:

$$( ref\_SFN + PF\_offset ) mod T = ( T / N ) * ref\_ID$$

where PF_offset is a paging frame offset value configured by the network, and T is a paging cycle period determined by the terminal. N is the number of paging frames in one paging cycle period. mod is the modulo operation.

In an optional embodiment, when the capacity D of the PEI occasion is less than Ns, according to the above method, different POs in one PF correspond to the same first reference frame. That is, a plurality of different PEI occasions corresponding to different POs use the same first reference frame. The network needs to configure a plurality of first offset values or second offset values used by different terminals to determine different PEI occasions using the same reference frame. When the terminal determines, according to the first reference frame, a PEI occasion to be monitored, the terminal needs to determine the first offset value and the second offset value used by the PEI occasion to be monitored.

Optionally, different POs in one PF use the same first offset value, and the terminal determines the second offset value according to the capacity D of the PEI occasion. Specifically, when the capacity D of the PEI occasion is less than or equal to Ns, the terminal determines that a sequence number i_s_pei of the second offset value of the PEI occasion is: i_s_pei=i_s/floor(Ns/D). When D can divide Ns evenly, the equation can be simplified to: i_s_pei=i_s *D/Ns. When the capacity D of the PEI is greater than Ns, the terminal determines that the sequence number i_s_pei of the second offset value of the PEI occasion is: i_s_pei=0, where is is the sequence number of the PO monitored by the terminal in the PF.

Optionally, different POs in one PF use different first offset values, and the terminal determines the first offset value according to the capacity D of the PEI occasion. Specifically, when the capacity D of the PEI occasion is less than or equal to Ns, the terminal determines that a sequence number i_s_pei of the first offset value of the PEI occasion is: i_s_pei=i_s/floor(Ns/D). When D can divide Ns evenly, the equation can be simplified to: i_s_pei=i_s *D/Ns. When the capacity D of the PEI is greater than Ns, the terminal determines that the sequence number i_s_pei of the first offset value of the PEI occasion is: i_s_pei=0,

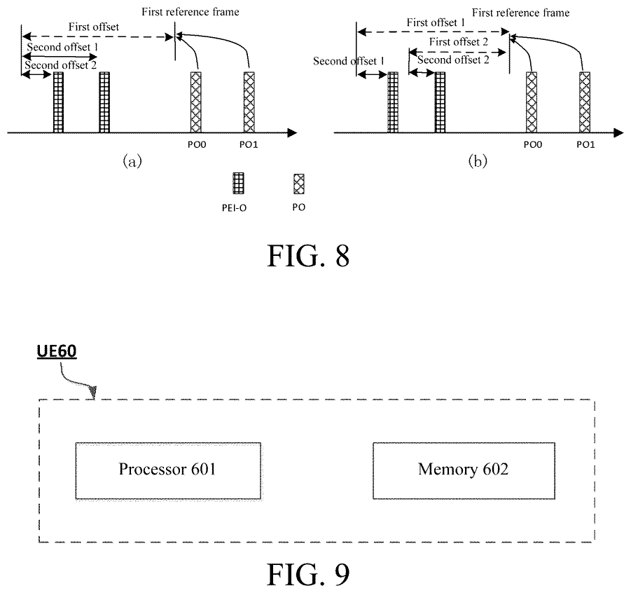

A specific example is as shown in FIG. 8, and in the drawing, one PF is associated with two POs, Ns=2. In addition, the capacity D of the PEI-DCI is 1. That is, one PEI-DCI indicates only whether a terminal monitoring one PO needs to monitor the PO. The terminal determines a first reference frame the capacity of the PEI-DCI and UE_ID, and the terminal when monitoring PO0 and PO1 determines the same first reference frame. In a method, as shown in FIG. 8(a), the terminal determines a first offset value, and the terminal determines the sequence number of a second offset value and the second offset value. The terminal can determine a starting point of a corresponding PEI occasion. In another method, as shown in FIG. 8(b), the terminal determines the sequence number of a first offset value and the first offset value, and the terminal determines the sequence number of a second offset value and/or the second offset value. The terminal can determine a starting point of a corresponding PEI occasion.

After the PEI occasion is determined, a related PEI-PDCCH monitoring occasion may be determined. A procedure for determining a PEI-PDCCH monitoring occasion is described below.

The network may indicate an SSB transmission parameter by means of an SIB or RRC message. For example, the network indicates, by means of an ssb-PositionsInBurst information element in SIB1, information such as the number and sequence numbers of actually-transmitted SSBs, etc. Different SSBs may correspond to different coverage directions, so that all terminals in an entire cell can perform downlink reception well. According to different configuration parameters of the SSB etc., in the network, one PEI occasion consists of several PEI-PDCCH monitoring occasions. The terminal determines several PEI occasions and several PEI-PDCCH monitoring occasions according to the PEI frame and the configuration parameters.

For example, the terminal determines that the PEI occasion includes X*S consecutive PEI-PDCCH monitoring occasions. Every S PEI-PDCCH monitoring occasions respectively correspond to S different SSB sequence numbers. Therefore, the (x*S+s)-th PDCCH monitoring occasion in each PEI occasion corresponds to the s-th actually-transmitted SSB sequence number. The value of X is configured by a higher layer. x=0, 1, . . . , X−1, and s=1, 2, . . . , S. Optionally, the higher layer does not configure the value of X, and the terminal uses X=1 to determine a corresponding PEI-PDCCH monitoring occasion sequence number. S is the number of actually-transmitted SSBs, and may be determined according to ssb-PositionsInBurst in SIB1.

Hereinafter, FIG. 9 is used to illustrate user equipment that can perform the method performed by user equipment described in detail above in the present invention as a variant embodiment.

FIG. 9 shows a block diagram of user equipment (UE) according to the present invention.

As shown in FIG. 9, the user equipment (UE) 60 includes a processor 601 and a memory 602. The processor 601 may include, for example, a microprocessor, a microcontroller, an embedded processor, and the like. The memory 602 may include, for example, a volatile memory (such as a random access memory (RAM)), a hard disk drive (HDD), a non-volatile memory (such as a flash memory), or other memories. etc. The memory 602 has program instructions stored thereon. The instructions, when run by the processor 601, can perform the above method performed by user equipment described in detail in the present invention.

The method and related equipment according to the present invention have been described above in combination with preferred embodiments. It should be understood by those skilled in the art that the method shown above is only exemplary, and the above embodiments can be combined with one another as long as no contradiction arises. The method of the present invention is not limited to the steps or sequences illustrated above. The network node and user equipment illustrated above may include more modules. For example, the network node and user equipment may further include modules that can be developed or will be developed in the future to be applied to a base station, an MME, or UE, and the like. Various identifiers shown above are only exemplary, and are not meant for limiting the present invention. The present invention is not limited to specific information elements serving as examples of these identifiers. A person skilled in the art could make various alterations and modifications according to the teachings of the illustrated embodiments.

It should be understood that the above-described embodiments of the present invention may be implemented by software, hardware, or a combination of software and hardware. For example, various components of the base station and user equipment in the above embodiments can be implemented by multiple devices, and these devices include, but are not limited to: an analog circuit device, a digital circuit device, a digital signal processing (DSP) circuit, a programmable processor, an application-specific integrated circuit (ASIC), a field-programmable gate array (FPGA), a complex programmable logic device (CPLD), and the like.

In the present application, the “base station” may refer to a mobile communication data and control exchange center having large transmission power and a wide coverage area, including functions such as resource allocation and scheduling and data reception and transmission. “User equipment” may refer to a user mobile terminal, for example, including terminal devices that can communicate with a base station or a micro base station wirelessly, such as a mobile phone, a laptop computer, and the like.

In addition, the embodiments of the present invention disclosed herein may be implemented on a computer program product. More specifically, the computer program product is a product provided with a computer-readable medium having computer program logic encoded thereon. When executed on a computing device, the computer program logic provides related operations to implement the above technical solutions of the present invention. When executed on at least one processor of a computing system, the computer program logic causes the processor to perform the operations (the method) described in the embodiments of the present invention. Such setting of the present invention is typically provided as software, codes and/or other data structures provided or encoded on the computer-readable medium, e.g., an optical medium (e.g., compact disc read-only memory (CD-ROM)), a flexible disk or a hard disk and the like, or other media such as firmware or micro codes on one or more read-only memory (ROM) or random access memory (RAM) or programmable read-only memory (PROM) chips, or a downloadable software image, a shared database and the like in one or more modules. Software or firmware or such configuration may be installed on a computing device such that one or more processors in the computing device perform the technical solutions described in the embodiments of the present invention.

In addition, each functional module or each feature of the base station device and the terminal device used in each of the above embodiments may be implemented or executed by a circuit, which is usually one or more integrated circuits. Circuits designed to execute various functions described in this description may include general-purpose processors, digital signal processors (DSPs), application-specific integrated circuits (ASICs) or general-purpose integrated circuits, field-programmable gate arrays (FPGAs) or other programmable logic devices, discrete gates or transistor logic, or discrete hardware components, or any combination of the above. The general purpose processor may be a microprocessor, or the processor may be an existing processor, a controller, a microcontroller, or a state machine. The aforementioned general purpose processor or each circuit may be configured by a digital circuit or may be configured by a logic circuit. Furthermore, when advanced technology capable of replacing current integrated circuits emerges due to advances in semiconductor technology, the present invention can also use integrated circuits obtained using this advanced technology.

While the present invention has been illustrated in combination with the preferred embodiments of the present invention, it will be understood by those skilled in the art that various modifications, substitutions, and alterations may be made to the present invention without departing from the spirit and scope of the present invention. Therefore, the present invention should not be limited by the above-described embodiments, but should be defined by the appended claims and their equivalents.

1-5. (canceled)

6. A User Equipment (UE), comprising:
a processor; and
a memory, wherein the memory stores instructions that cause the processor to:
receive a System Information Block (SIB) for the UE in IDLE or INACTIVE state, the SIB including a configuration of Channel State Information Reference Signal (CSI-RS) resource sets and a configuration of a group number for each of the CSI-RS resource sets;
receive Downlink Control Information (DCI) for the UE in IDLE or INACTIVE state, the DCI including a CSI-RS availability indication; and
determine availabilities of the CSI-RS resource sets according to the group number for each of the CSI-RS resource sets for the SIB and the CSI-RS availability indication for the DCI, wherein
a number of bits for the CSI-RS availability indication is equal to one plus the highest value of all the group numbers for the CSI-RS resource sets.

7. A control method in a User Equipment (UE), comprising:
receiving a System Information Block (SIB) for the UE in IDLE or INACTIVE state, the SIB including a configuration of Channel State Information Reference Signal (CSI-RS) resource sets and a configuration of a group number for each of the CSI-RS resource sets;
receiving Downlink Control Information (DCI) for the UE in IDLE or INACTIVE state, the DCI including a CSI-RS availability indication; and
determining availabilities of the CSI-RS resource sets according to the group number for each of the CSI-RS resource sets for the SIB and the CSI-RS availability indication for the DCI, wherein
a number of bits for the CSI-RS availability indication is equal to one plus the highest value of all the group numbers for the CSI-RS resource sets.
